(19) United States
(12) Patent Application Publication
(10) Pub. No.: US 2023/0380629 A1
(43) Pub. Date: Nov. 30, 2023

(54) COFFEE GRINDING APPARATUS COMPRISING A REMOVABLE ACCESSORY FOR CONTAINING THE DISPERSION OF GROUND COFFEE

(71) Applicant: DE' LONGHI APPLIENCES S.r.l., Treviso (IT)

(72) Inventors: Giovanni ROSSETTO, Treviso (IT); Stefano BOLZONELLO, Treviso (IT); Alessandro BELLESE, Treviso (IT); Maurizio CASASOLA, Treviso (IT)

(73) Assignee: DE' LONGHI APPLIENCES S.r.l., Treviso (IT)

(21) Appl. No.: 18/032,419

(22) PCT Filed: Oct. 21, 2021
(86) PCT No.: PCT/EP2021/079175

§ 371 Date: Apr. 22, 2023

(30) Foreign Application Priority Data
Oct. 22, 2020 (IT) 102020000025090

(51) Int. Cl. A47J 42/40; A47J 31/42

(52) U.S. Cl. CPC A47J 42/40; A47J 31/42

(57) ABSTRACT

A coffee grinding apparatus comprising a coffee grinder, a removable filter holder and a cradle positioned below the coffee grinder, the cradle has above the filter holder a support shelf delimiting an opening passing the ground coffee, below the cradle an actuator actuates an activation switch of the coffee grinder, where a removable accessory contains the dispersion of ground coffee flowing towards a filter of the removable filter holder, the removable accessory formed by a sleeve connecting the opening in the support shelf to the upper mouth of a cup of the filter holder, the sleeve having a lower release and quick couple to the upper mouth of the cup and a removable upper engagement with the support shelf, the removable upper engagement comprising a perimeter flange of the sleeve resting on the support shelf, the sleeve being configured and arranged to interact with the actuator below the perimeter flange.

### CROSS-REFERENCE TO RELATED APPLICATIONS

The present application is a U.S. national phase application under 35 U.S.C. § 371 of International Patent Application No. PCT/EP2021/079175, filed Oct. 21, 2021, which claims priority to Italian Patent Application No. 102020000025090, filed Oct. 22, 2020. The entire contents of which are hereby incorporated by reference.

### FIELD OF THE INVENTION

The present invention relates to a coffee grinding apparatus comprising a removable accessory for containing the dispersion of ground coffee.

### BACKGROUND

Coffee grinding apparatuses have been on the market for some time both in the stand-alone configuration and integrated into a machine for making coffee.

Apparatuses for grinding coffee are known, which are predisposed for loading ground coffee directly into a filter holder cup, which is then translated into a station for pressing the dry grounds and then to the infusion station of a machine for making coffee, which may be automatic, semi-automatic or manual.

It is known that such filter holders, where the filter is generally removable, are associated with a longitudinal handle for easy movement and means for support and/or fixing to corresponding support means of the coffee grinding apparatus, for a correct mutual positioning with the ground coffee loading means.

As is known, the loading of ground coffee into the filter in the filter holder cup takes place traditionally by the grounds dropping through a hopper from a grinder placed above the filter holder cup.

Such traditional configuration notoriously implies the possible dispersion of the grounds outside the filter holder cup, as the lower opening of the hopper and the upper opening of the filter holder cup during the loading step are not in contact.

Any excess dry grounds with respect to the upper edge of the filter holder cup can then be dispersed in the transfer of the filter holder from the loading station of the coffee grinder to the pressing station, and/or during the pressing step itself.

There is therefore a need to improve the structure of known coffee grinding apparatuses.

### SUMMARY

The technical task of the present invention is, therefore, to provide a coffee grinding apparatus which obviates the above-described technical drawbacks of the prior art.

Within the context of this technical task an object of the invention is to realize a coffee grinding apparatus which prevents a dispersion of the grounds outside the filter holder cup during the loading step.

Another object of the invention is to realize a coffee grinding apparatus that prevents a dispersion of the grounds during the step of transferring the filter holder from the loading station to the pressing station.

Another object of the invention is to realize a coffee grinding apparatus which enables a step of loading the ground coffee into the filter holder cup in hands-free conditions.

Not least, an object of the invention is to realize a coffee grinding apparatus which enables the activation of the step of loading the ground coffee into the filter holder cup in hands-free conditions.

The technical task, as well as these and other objects, according to the present invention are achieved by realizing a coffee grinding apparatus comprising a coffee grinder, a removable filter holder and a cradle positioned below the coffee grinder, where said filter holder has a longitudinal handle, a cup, a filter housed in said cup and a plurality of flaps which extend externally to said cup, said cradle having above said filter holder a support shelf delimiting an opening for the passage of the ground coffee, an actuator further being provided for actuating an activation switch of said coffee grinder, said actuator being positioned below said cradle, characterized in that it comprises a removable accessory for containing the dispersion of ground coffee flowing towards said filter of said removable filter holder, said removable accessory being formed by a sleeve connecting said opening in said support shelf to the upper mouth of said cup of said filter holder, said sleeve having a lower quick coupling and release means to said upper mouth of said cup of said filter holder and a removable upper engagement means with said support shelf, said removable upper engagement means comprising a perimeter flange for resting on said support shelf, said sleeve being configured and arranged to interact with said actuator below said perimeter flange.

The interaction with the actuator advantageously takes place in a protected recess without any dust delimited between the outer upper perimeter flange of the sleeve and an outer lower perimeter flange of the sleeve which supports said quick coupling and release means.

The actuator is not contaminated with the coffee powder which could, if present, create friction and jamming of the actuator when it moves from and towards the switch.

Other features of the present invention are further defined in the following claims.

### BRIEF DESCRIPTION OF THE DRAWINGS

Further characteristics and advantages of the invention will become more apparent from the description of a preferred, but not exclusive, embodiment of a coffee grinding apparatus according to the invention, illustrated by way of indicative and non-limiting example in the accompanying drawings, in which:

FIG. 1 shows an assembly view of a filter holder;

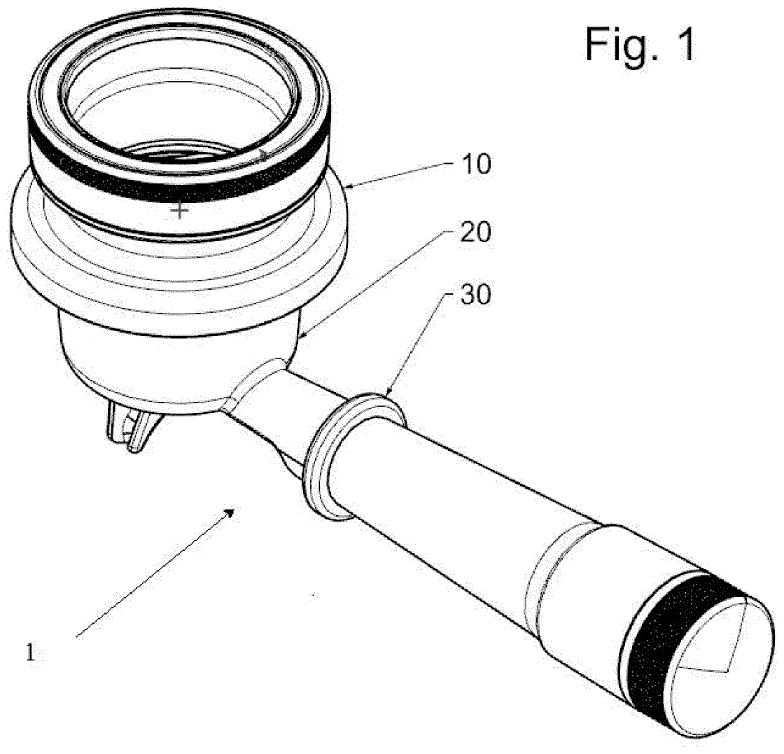

FIG. 2 shows an assembly view of a filter holder and of a support cradle of the filter holder;

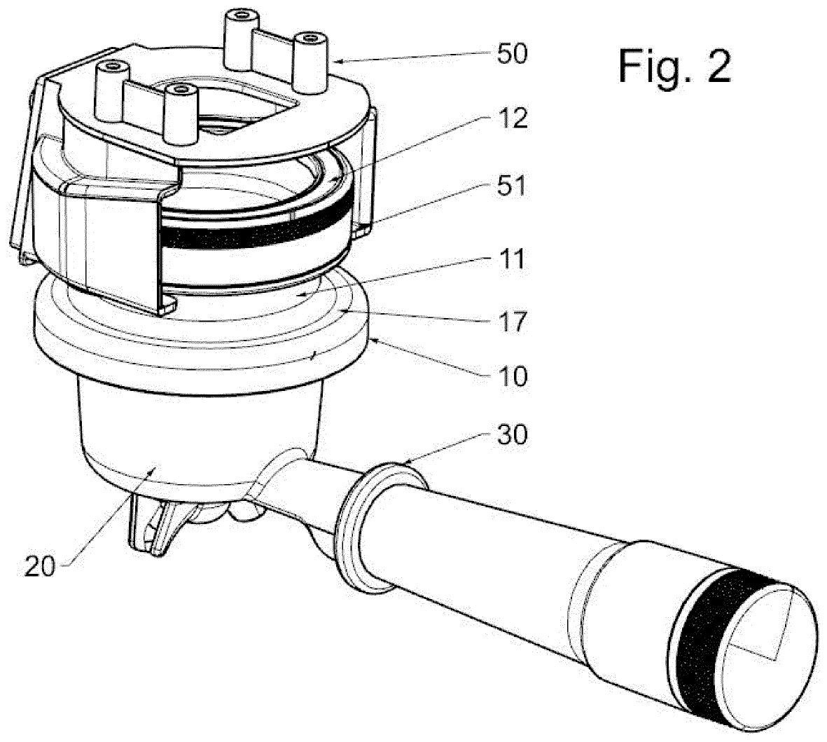

FIG. 3 is a transparent view of the filter holder—removable accessory assembly;

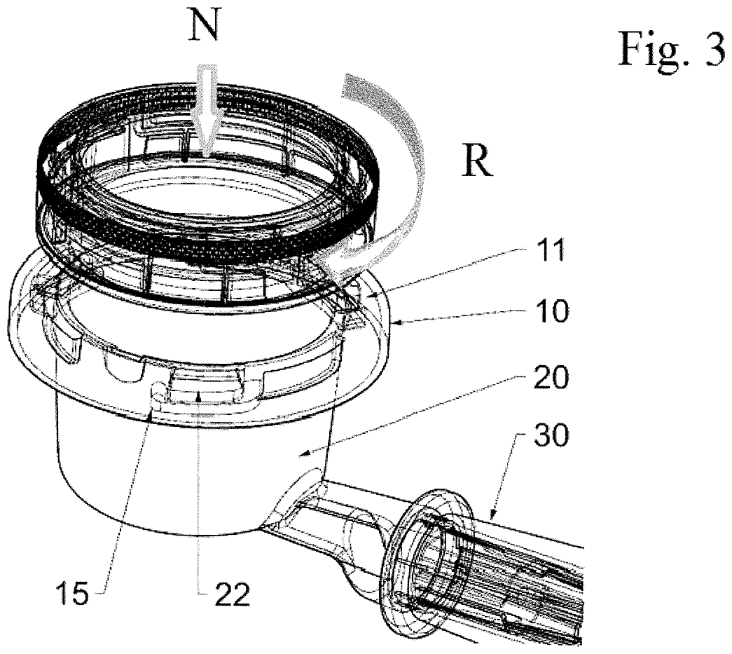

FIG. 4A shows a vertical section of the filter holder—support cradle assembly;

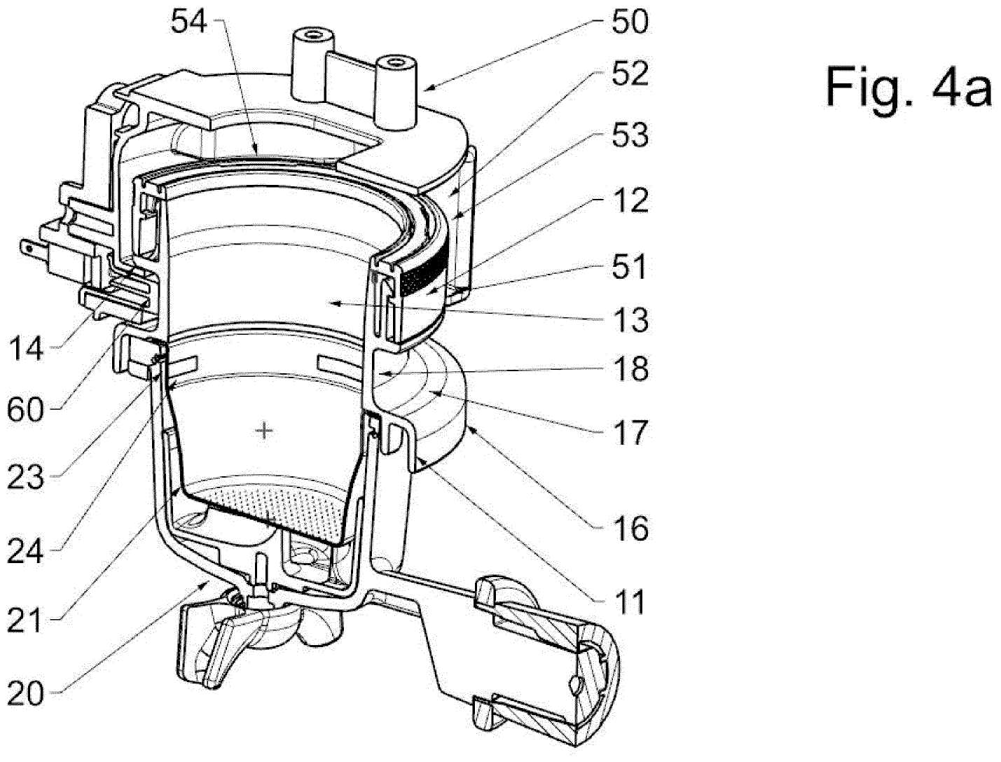

FIG. 4B shows the cradle without the filter holder; and

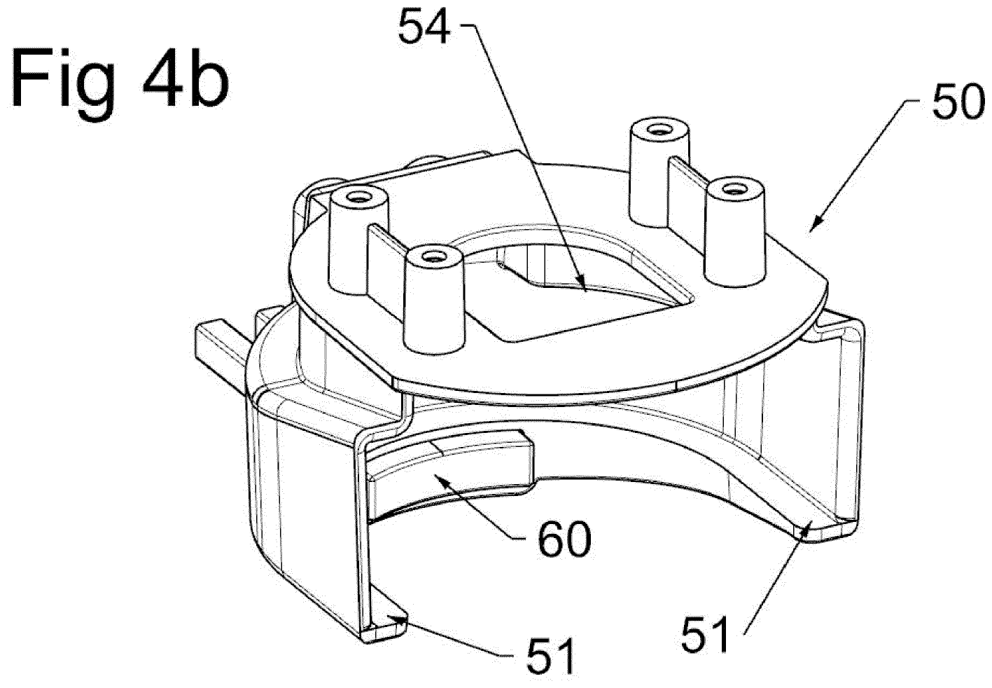

FIG. 5 shows a vertical section of the filter holder—support cradle assembly in a second preferred embodiment.

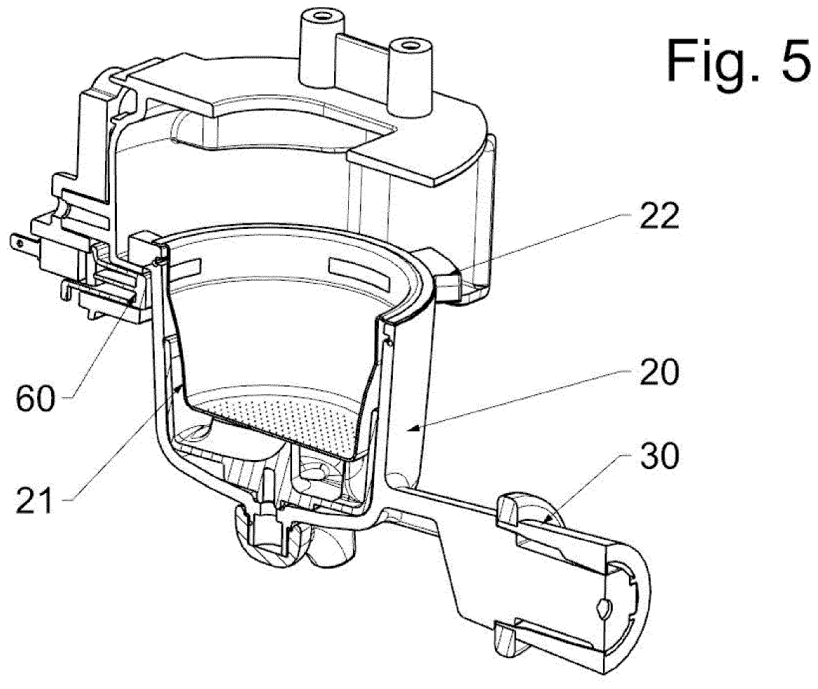

### DETAILED DESCRIPTION

With reference to the figures mentioned, a removable filter holder 1s shown indicated overall with the reference number 1.

For presentation and reading simplicity the coffee grinder, pressing station and infusion station complex of a coffee machine of the known type are not highlighted in the figures.

The coffee grinder has a cradle 50 positioned below the grinder for housing the removable filter holder 1 in the grounds loading step.

The filter holder 1 has a longitudinal handle 30, a cup 20, a filter 21 for collecting the grounds removably housed in the cup 20, and a plurality of flaps 22 which extend externally to the cup 20.

The cradle 50 has above the filter holder a support shelf 51 delimiting an opening 52 for the passage by dropping of the coffee grounds from the grinder to the filter 21.

The support shelf 51 has a front discontinuity at the insertion axis of the filter holder 1 in the grinding apparatus.

Advantageously, according to the present invention, a removable accessory 10 is provided for containing the dispersion of ground coffee flowing towards the filter 21 of the removable filter holder 1, formed by a sleeve 11 connecting the opening 52 in the support shelf 51 to the upper mouth 23 of the cup 20 containing the filter 21.

The sleeve 11 has an inner perimeter wall 13 matching up with an inner perimeter wall 24 of the filter 21; typically, the inner perimeter wall 13 of the sleeve 11 and the matching inner perimeter wall 24 of the filter 21 are cylindrical.

Appropriately, the sleeve 11 has both a lower release and quick coupling means to the upper mouth 23 of the cup 20 of the filter holder 1 and a removable upper engagement means with the support shelf 51.

The removable upper engagement means of the sleeve 11 with the support shelf 51 comprises a perimeter flange 12 which extends externally along the outer perimeter of an upper base 14 of the sleeve: the perimeter flange 12 is configured to rest along a perimeter surface 53 of the opening 52 in the support shelf 51.

More precisely, the perimeter flange 12 has a horizontal flat lower surface resting along a horizontal flat upper surface 53 of the support shelf 51.

The lower release and quick coupling means of the sleeve 11 comprises elastically yielding engagement seats 15 for the flaps 22 of the cup 20, and extends along the outer perimeter of a lower base 16 of the sleeve 11.

Advantageously, according to the present invention, the cradle 50 has, above the support shelf 51, an anti-tip shelf 54 for preventing the tipping of the removable accessory 10, configured and arranged to interact with the perimeter flange 12, in particular with areas of the perimeter flange 12 distanced from a vertical plane containing the axis of the filter holder handle.

A further advantageous characteristic of the coffee grinding apparatus described herein, is the fact that it comprises in a position below the cradle 50 an actuator 60 for actuating an activation switch of the coffee grinder: the removable accessory is configured and arranged to interact with such an actuator 60.

In particular, the sleeve 11 interacts with the actuator 60 at a recess 18 delimited between the outer upper perimeter flange 12 of the sleeve 11 and an outer lower perimeter flange 17 of the sleeve 11.

The outer lower perimeter flange 17 of the sleeve 11 on the opposite side to the side facing towards the outer upper perimeter flange 12 supports the quick coupling and release means.

In a second use configuration of the present invention, the coffee grinding apparatus has no removable accessory 10; in such a use configuration the flaps 22 of the cup 20 are directly engaged resting on the support shelf 51 of the cradle 50, and the cup 20 interacts with the actuator 60 of the coffee grinder activation switch.

The subject matter of the present invention further relates to a coffee machine incorporating a grinding apparatus in compliance with the above description, where the filter holder 1 loaded with ground coffee is removably engageable with an infusion head of the coffee machine by means of the flaps 22 including a front flap 22A and a pair of rear flaps 22P.

The operation of the coffee grinding apparatus according to the invention appears clear from the description and illustration and, in particular, is substantially as follows. The sleeve 11 of the removable accessory 10 is engaged with the upper mouth 23 of the cup of the filter holder 1 by means of its own lower release and quick coupling means: the elastically yieldable seats 15 which extend along the outer perimeter of the lower base 16 of the sleeve 11 engage with the flaps 22 which extend externally to the cup 20 with a pressing-rotation movement, typically in the clockwise direction.

The filter holder 1 thus equipped with the removable accessory 10 is grasped by the user by the longitudinal handle 30, and engaged with the coffee grinding apparatus with an axial advancement movement, in the direction of the longitudinal axis of the handle 30.

The perimeter flange 12 engages at the bottom with the support shelf 51 along the perimeter surface 53 of the opening 52.

As it gets close to the stroke end of the axial advancement, the perimeter flange 12 engages at the top with the anti-tip shelf 54 of the cradle 50, configured to prevent the tipping of the filter holder 1 thus enabling the coffee grounds to be loaded in so-called hands-free conditions by the user.

Upon reaching the stroke end of the axial advancement of the filter holder 1, the sleeve 11 of the removable accessory 10 below the perimeter flange 12 interacts with the actuator 60 which is below the cradle 50 in a position protected by the perimeter flange 12. The actuator actuates the activation switch of the coffee grinder, which therefore starts the operations of grinding and unloading the coffee grounds by gravity from the opening 52 through the sleeve 11 into the upper mouth 23 of the cup 20 containing the filter 21, still in so-called hands-free conditions by the user.

As mentioned, the continuous support of the perimeter flange 12 with the support shelf 51 along the perimeter surface 53 of the opening 52 protects the actuator 60 below from any deposit of dry ground coffee powder, preserving the cleaning and operating integrity.

The flange 12 then provides a series of functions that cooperate synergistically, such as the support function for the accessory, the anti-tip function for the accessory and the protection function for the actuator.

The coffee grinding operations are handled by a command, dosing and control means of the known type, on board the coffee grinder.

The sleeve 11 guarantees the guided passage of the grounds from the opening 52 to the upper mouth 23 preventing any dispersions of dry grounds, and providing for the containment of any excesses with respect to the upper edge of the mouth 23; the continuity of the inner perimeter wall 13 of the sleeve 11 with the matching inner perimeter wall 24 of the filter 21 guarantees an orderly flow of dry ground coffee powder falling into the filter 21.

The filter holder 1 with the envisaged dose of ground dry coffee is then removed from the grinding apparatus with axial movement contrary to the advancement, and translated by the user to the grounds pressing station, where the sleeve 11 of the removable accessory advantageously contains any further dispersions of dry grounds between the pressing means and the filter 21 in the cup 20.

Advantageously, the continuity of the inner perimeter wall 13 of the sleeve 11 with the matching inner perimeter wall 24 of the filter 21 guarantees a slidable and correct guide of the pressing means along a common pressing axis to the sleeve 11 and filter 21.

The removable accessory 10 is then removed by the user with a pressing-rotation action in the opposite direction with respect to the mounting direction, typically anti-clockwise, releasing the elastically yielding seats 15 from the engagement with the flaps 22 of the filter holder cup 20.

The filter holder 1 loaded with pressed coffee grounds is then translated by the user to the infusion head of a coffee machine where it is removably engageable by means of the flaps 22, typically including the front flap 22A and the pair of rear flaps 22P.

In a second use configuration of the present invention, the coffee grinding apparatus has a filter holder 1 without the removable accessory 10; in such use configuration the flaps 22 of the cup 20 are directly engaged resting on the support shelf 51 of the cradle 50, and the cup 20 interacts with the actuator 60 of the coffee grinder activation switch. However, in this case, grinding in hands-free conditions is not possible as the perimeter flange 12 would have a tipping trajectory that no longer interferes with the anti-tip shelf 54.

Modifications and variations in addition to those described are naturally possible.

It has in practice been noted how a coffee grinding apparatus according to the invention is particularly advantageous in order to prevent any dispersion of the grounds outside the filter holder cup during the loading step and reliable operation of the grinder activation system.

A coffee grinding apparatus according to the invention is further particularly advantageous because it enables a step of loading the coffee grounds into the filter holder cup in hands-free conditions.

Not least, an advantage of the invention is to propose a coffee grinding apparatus which enables the activation of the step of loading the coffee grounds into the filter holder cup in hands-free conditions.

A coffee grinding apparatus as conceived herein is susceptible to many modifications and variants, all falling within the scope of the inventive concept as defined by the claims; furthermore, all the details are replaceable by technically equivalent elements.

In practice, the materials used, as well as the dimensions, can be any according to the needs and the state of the art.

1. A coffee grinding apparatus comprising a coffee grinder, a removable filter holder and a cradle positioned below the coffee grinder, where said filter holder has a longitudinal handle, a cup having an upper mouth, a filter housed in said cup and a plurality of flaps which extend externally to said cup, where said cradle has above said filter holder a support shelf delimiting an opening permitting the passage of the ground coffee, where below said cradle is disposed an actuator actuating an activation switch of said coffee grinder, where a removable accessory contains the dispersion of ground coffee flowing towards said filter of said removable filter holder, said removable accessory being formed by a sleeve connecting said opening, in said support shelf to said upper mouth of said cup said sleeve having a lower release and quick couple to said upper mouth of said cup and a removable upper engagement means with said support shelf, said removable upper engagement comprising a perimeter flange resting on said support shelf, said sleeve being configured and arranged to interact with said actuator below said perimeter flange.

2. The coffee grinding apparatus according to claim 1, wherein said sleeve interacts with said actuator at a recess delimited between said outer upper perimeter flange of said sleeve and an outer lower perimeter flange of said sleeve which on an opposite side to a side turned towards said outer upper perimeter flange supports said release and quick couple.

3. The coffee grinding apparatus according to claim 1, wherein said perimeter flange extends along the outer perimeter of an upper base of said sleeve.

4. The coffee grinding apparatus according to claim 3, wherein said perimeter flange has a horizontal flat lower surface resting along a horizontal flat upper surface of said support shelf which surrounds said opening.

5. The coffee grinding apparatus according to claim 1, wherein said cradle has an anti-tip shelf preventing the tipping of said removable accessory.

6. The coffee grinding apparatus according to claim 5, wherein said anti-tip shelf is configured and arranged to interact with said perimeter flange.

7. The coffee grinding apparatus according to claim 1, wherein said sleeve has an inner perimeter wall matching up with an inner perimeter wall of said filter.

8. The coffee grinding apparatus according to claim 7, wherein said inner perimeter wall and said matching inner perimeter wall are cylindrical.

9. The coffee grinding apparatus according to claim 1, wherein said release and quick couple comprises elastically yielding engagement seats for said flaps.

10. The coffee grinding apparatus according to claim 9, wherein said elastically yielding engagement seats extend along the outer perimeter of a lower base of said sleeve.

11. The coffee grinding apparatus according to claim 1, further comprising a use configuration without said removable accessory in which said flaps are engaged resting on said support shelf and said cup interacts with said actuator for activating the switch.

12. A coffee machine incorporating a grinding apparatus in compliance with claim 1, wherein said filter holder is removably engageable with an infusion head of the coffee machine by means of said flaps including a front flap and a pair of rear flaps.
